(19) United States
(12) Patent Application Publication
(10) Pub. No.: US 2021/0344711 A1
(43) Pub. Date: Nov. 4, 2021

(54) Phishing Detection Method And System

(71) Applicant: Pixm, New York, NY (US)

(72) Inventors: Chris Farrell Cleveland, New York, NY (US); Arun Kumar Buduri, Somerville, MA (US)

(21) Appl. No.: 17/368,196

(22) Filed: Jul. 6, 2021

Related U.S. Application Data
(63) Continuation of application No. 16/026,637, filed on Jul. 3, 2018, now abandoned.
(60) Provisional application No. 62/529,175, filed on Jul. 6, 2017.

(51) Int. Cl. H04L 29/06; G06F 21/51; G06N 3/08; G06K 9/32; H04L 29/08; G06K 9/20; H04L 9/32; G06Q 10/10; G06N 3/04

(52) U.S. Cl. CPC H04L 63/1483; G06F 21/51; G06N 3/08; G06K 9/3241; H04L 67/104; G06F 2221/2119; H04L 9/3236; G06Q 10/107; H04L 9/3247; G06N 3/0454; G06K 9/2054

(57) ABSTRACT

A method of detecting a phishing event comprises acquiring an image of visual content rendered in association with a source, and determining that the visual content includes a password prompt. The method comprises performing an object detection, using an object detection convolutional network, on a brand logo in the visual content, to detect one or more targeted brands. Spatial analysis of the visual content may be performed to identify one or more solicitations of personally identifiable information. The method further comprises determining, based on the object detection and the spatial analysis, that at least a portion of the visual content resembles content of a candidate brand, and comparing the domain of the source with one or more authorized domains of the candidate brand. A phishing event is declared when the comparing indicates that the domain of the source is not one of the authorized domains of the candidate brand.

### RELATED APPLICATIONS

This application is a continuation of U.S. application Ser. No. 16/026,637, filed Jul. 3, 2018, which claims the benefit of U.S. Provisional Application No. 62/529,175, filed on Jul. 6, 2017. The entire teachings of the above applications are incorporated herein by reference.

### BACKGROUND

Phishing is an attempt to obtain personally identifiable information (PII—e.g., passwords, credit card information, Social Security numbers, etc.), or money/property, by impersonating a trusted entity. Phishing initiated breaches are well known to be the source of more than 90% of cyber-security breaches, such as the attacks that penetrated the 2016 United States election campaigns and major United States corporations.

### SUMMARY

The described embodiments are directed to systems for, and methods of, preventing phishing breaches. The described embodiments are configured to proactively identify deceptive phishing communications, such as emails and URLs, across an array of communications platforms.

In one aspect, the invention may be a method of detecting a phishing event implemented by a processor and a memory with computer code instructions stored thereon, the memory operatively coupled to the processor. When executed by the processor, the computer code instructions may cause the system to acquire an image of visual content rendered in association with a source, identify a domain of the source, and perform an object detection using an object detection convolutional neural network (CNN), on one or more brand logos located within the visual content, to detect an instantiation of one or more targeted brands. The executing code instructions may further cause the system to determine, based on the object detection, that at least a portion of the visual content resembles content of a candidate brand, to compare the domain of the source with one or more authorized domains of the candidate brand, and declare a phishing event when the comparing indicates that the domain of the source is not one of the authorized domains of the candidate brand.

The source may be a uniform resource locator (URL), and the visual content may originate from an entity associated with the URL.

An embodiment may further comprise determining that the visual content includes personally identifiable information. The object detection may be performed as a first agent, and the remaining steps may be performed as a second agent. The first agent may be configured to operate on a first hardware platform, and the second agent may be configured to operate on a second hardware platform.

An embodiment may further comprise, upon declaring a phishing event, displaying an indication of one or more of (i) relevant logo, (ii) brand detection, (iii) authorized domain associated with the detected brand, (iv) domain detected as being associated with the detected brand, (v) domain detected as being associated with the URL, and (vi) notification as to a mismatch between the domain detected as being associated with the detected brand and the domain detected as being associated with the URL.

An embodiment may further comprise performing a visual fingerprinting of the image of visual content, by generating a visual hash of the visual content and comparing the generated visual hash to one or more hashes of known phishing examples, and declaring a phishing event when the generated visual hash matches at least one of the hashes of known phishing examples.

The source may be an email agent configured to compile and communicate email content. The visual content may be at least a part of the email content.

An embodiment may further comprise, upon declaring a phishing event, displaying an indication of one or more of (i) a notification that an address of the email content does not match a sender domain and (ii) an indication of an identified target brand.

In another aspect, the invention may be a method of detecting a phishing event, comprising acquiring an image of rendered visual content, generating image coordinates associated with an action triggered by a user click on the image, cropping a region of the image according to the coordinates to form a cropped region, and identifying a characteristic corresponding to a final terminus associated with the triggered action. The method may further comprise performing an object detection, using an object detection convolutional network (CNN), on the cropped region of the image to detect a brand logo located within the region, and determining, based on the object detection, that the detected brand logo resembles content of a candidate brand. The method may further comprise comparing the characteristic associated with the triggered action, with one or more authorized characteristics associated with the candidate brand, and declaring a phishing event when the comparing indicates that the characteristic associated with the triggered action is not one of the authorized characteristics of the candidate brand.

The triggered action may be an activation of an embedded link, and the characteristics associated with the triggered action and the candidate brand may be authorized domain destinations. The triggered action may be an activation of a download event, and the characteristics associated with the triggered action and the candidate brand are authorized file formats. The object detection may be performed by a first agent, and the remaining steps may be performed by a second agent. The first agent may be configured to operate on a first hardware platform, and the second agent may be configured to operate on a second hardware platform.

In another aspect, the invention may be a method of detecting an unauthorized password event, comprising receiving a password entered by a user into a webpage password prompt, determining a domain associated with the webpage, and upon receiving the password, halting a submission of the password to a source of the webpage. The method may further comprise querying a password-domain record for a list of domains approved for the password, comparing the domain associated with the webpage to the domains approved for the password, preventing the password from being sent to the webpage when the domain associated the webpage does not match one or more of the associated domains.

The password-domain record may comprise at least one of (i) a hash of the password associated with the approved domain, and (ii) the hash of the password associated with the approved domain, and one or both of (a) a hash associated with the approved domain (the hash being a hash of the password and the device ID), and (b) a hash associated with the approved domain (the hash being a hash of the password, the device ID, and a domain ID).

In another aspect, the invention may be a method of detecting a phishing event, comprising sending, by a first user, an email associated with a sender domain, generating a sender hash based on one or more components of the email, and storing the sender hash in a data storage facility. The method may further comprise receiving, by a second user, the email, determining that the sender domain is an accepted organization domain. When the determining establishes that the sender domain is the accepted organization domain, generating a receiver hash based on the one or more components of the email. The method may further comprise retrieving the sender hash from the memory declaring a phishing event when the sender hash does not match the receiver hash.

An embodiment may further comprise, upon receiving the email, comparing the sender domain to a domain associated with the receiver, and skipping the steps that follow receiving the email when the sender domain is different from the receiver domain.

The data storage facility may be one of (i) a remote database memory and (ii) a distributed data storage ledger. The distributed data storage ledger may consist of a set of nodes that maintain independent records, each of which is validated according to a private consensus procedure.

The data storage facility may be a distributed data storage ledger, and an embodiment may further comprise digitally signing the hash header, by the first user, based on a private key of a key pair, timestamping the signed hash header, and conveying the signed and timestamped hash header to a leader node in a peer-to-peer network. The embodiment may further comprise broadcasting, by the leader node, the signed and timestamped hash header to one or more peer nodes in the peer-to-peer network. The method may further comprise verifying, by the one or more peer nodes, the signed and timestamped hash header by validating the signature and determining that the associated public key belongs to a user in a corresponding organization, and returning a verification result to the leader node. The method may further comprise declaring a consensus, by the leader node, based on the received verification result, according to a private consensus procedure, and broadcasting, by the leader node, a command to insert the timestamped hash header into a storage ledger of each peer node.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1A illustrates an example of the first LUT 100 according to the invention.

FIG. 1B illustrates an example of the second LUT 110 according to the invention.

FIG. 2 illustrates the quantity and diversity of naturally occurring web logos for even a specific example logo.

FIGS. 3A through 3F show the diversity of some example phishing pages that mimic a legitimate brand source.

FIG. 4A summarizes the example logEye procedure according to an embodiment of the invention.

FIG. 4B illustrates an alternative example embodiment of the logEye procedure according to the invention.

FIG. 5 illustrates an example of a user interface according to the invention.

FIG. 6A summarizes an example mailEye embodiment according to the invention.

FIG. 6B illustrates an example embodiment of the first LUT shown in FIG. 6A

FIG. 6C illustrates an example embodiment of the second LUT shown in FIG. 6A.

FIGS. 7A and 7B illustrate an example of a user alert according to the invention.

FIGS. 8A and 8B illustrate an example embodiment of the first LUT and the second LUT of the clickEye embodiment of the invention.

FIG. 9 illustrates an example embodiment of the clickEye Icon Download Verification procedure according to the invention.

FIG. 10 illustrates an example embodiment of the LUT 1002 according to the invention.

FIG. 11 illustrates an example embodiment of the lockPass procedure according to the invention.

FIG. 12 illustrates an example embodiment of the lockPass procedure according to the invention.

FIG. 13 summarizes an alternative lockPass embodiment according to the invention.

FIG. 14 illustrates an alternative lockPass embodiment according to the invention.

FIG. 15 illustrates an example embodiment of the internal keyMail procedure according to the invention.

FIG. 16A illustrates an example embodiment of the global keyMail procedure according to the invention.

FIG. 16B illustrates an example domain record LUT shown in FIG. 16A.

FIG. 17 illustrates an example embodiment of the chainMail procedure according to the invention.

FIG. 18 is a diagram of an example internal structure of a processing system that may be used to implement one or more of the embodiments herein.

### DETAILED DESCRIPTION

A description of example embodiments follows.

The teachings of all patents, published applications and references cited herein are incorporated by reference in their entirety.

The described embodiments are directed to methods of, and systems for, detecting a phishing event and executing actions for correcting, preventing, mitigating, and/or otherwise addressing actual or potential consequences of the phishing event. An example embodiment described below (referred to herein as “logEye”) presents certain underlying concepts of the invention through the description of a specific application of the invention. Subsequent example embodiments (referred to herein as “mailEye,” “clickEye,” “lockPass,” “keyMail,” and “chainMail”) describe other examples of the invention. The example embodiments described herein are intended to be demonstrative of various aspects of the invention, and are not intended to be construed as limiting.

### LogEye

LogEye is a computer-based process that detects deceptive login pages on user devices (e.g., personal computer (PC), laptop computer, smartphone, et al.). Using an object detection convolutional network and at least one lookup table (LUT) stored on a device, logEye may alert users when familiar logos of legitimate entities appear on unauthorized login domains.

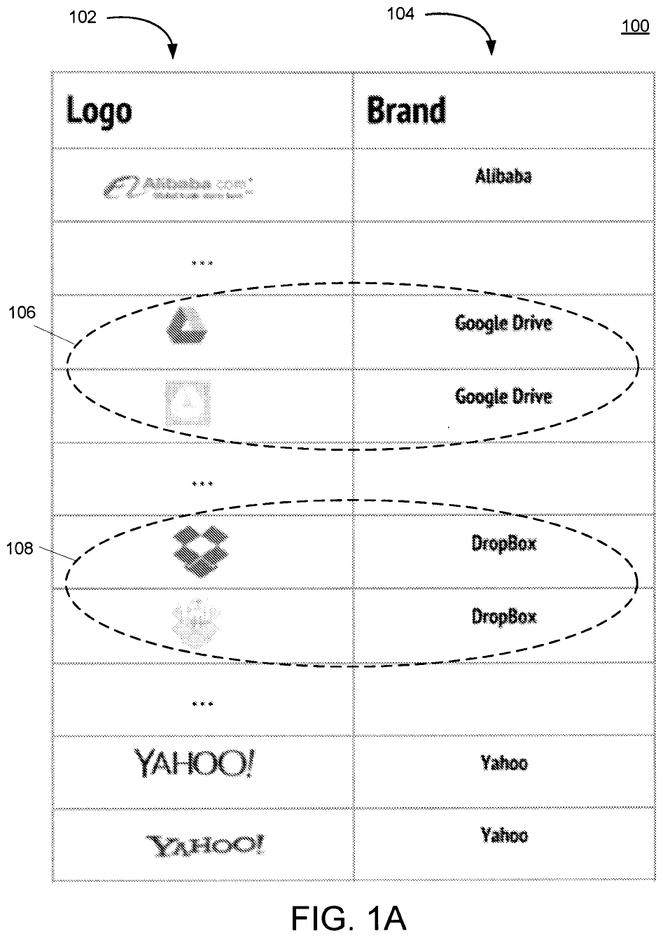

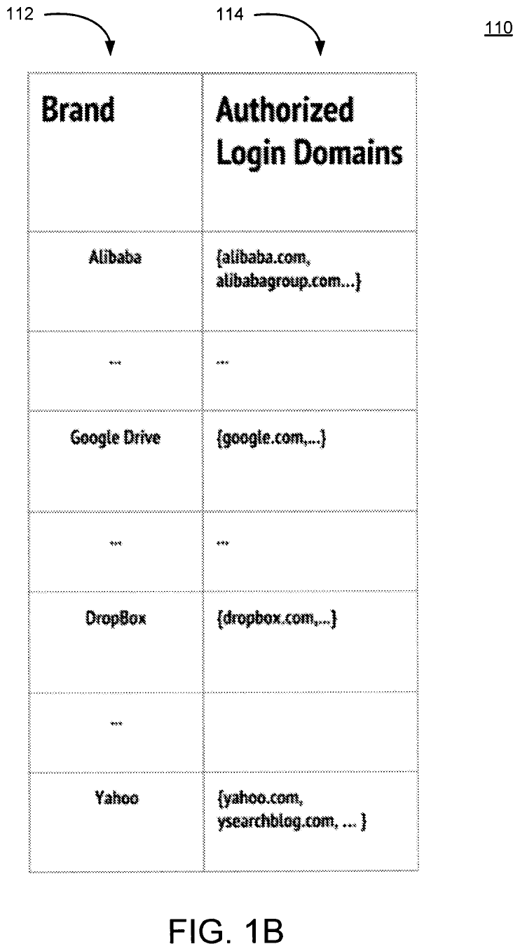

An example logEye embodiment may include a pair of LUTs stored on the user device. The first LUT may associate one or more logo images or sets of logo images with a particular brand name or brand identification (ID). The entity associated with the brand name or ID routinely displays the logo image(s) its online login pages, and otherwise commonly uses the logo image to advertise itself to its customers or employees. The brands in the table may be commonly used and well-known online brands (e.g., Google, DropBox, Paypal) or they may be lesser known brands that interact only with a small group of users (e.g., an accounting firm whose employees see its logo when they login to use its own online accounting software). FIG. 1A illustrates an example of the first LUT 100 according to the invention. A first column 102 includes logo images, and a second column 104 includes corresponding brand names. It should be understood that two or more images (i.e., image variations) may be associated with a particular brand, as demonstrated by the Google Drive pair 106 and the DropBox pair 108. The LUTs may be implemented

The second LUT 110 associates each brand identified in the first LUT 100 (see brand column 112 in FIG. 1B) with one or more authorized login domains or sets of authorized domains (see column 114 in FIG. 1B).

LogEye further includes an object detection convolutional neural network that is trained to detect the logo images listed in the first LUT 100 on a screenshot (i.e., an image of the visual content) of a web page. A web page screenshot is identical to the image produced on a user interface (UI) display by a web browser when it renders a URL to a user. This object detection convolutional network may be trained with standard gradient descent procedures known in the art, using labelled examples of web page screenshots containing logos in the table. A labelled example consists of a web screenshot image and the identity and location coordinates (i.e., bounding box coordinates) of a logo in the table. These examples may include one or more of (i) legitimate login pages of the associated brand, (ii) archived phishing pages of the associated brand, or (iii) other web pages that include the logo, among others. Once the object detection convolutional network is trained, the object detection convolutional network may receive an input image and produce the identity (i.e., the brand name or brand ID) and location, within the web page, of the logo that it detects.

As described herein, an object detection convolutional network refers to any convolutional network that generates convolutional features shared between the region proposal component and the classification component of the convolutional network. Examples of these approaches may include, among others, (1) S. Ren, K. He, R. Girshick, and J. Sun., Faster R-CNN. Towards real-time object detection with region proposal networks, In NIPS, 2015, (2) W. Liu, D. Anguelov, D. Erhan, C. Szegedy, and S. Reed, SSD: Single shot multibox detector, arXiv:1512.02325v2, 2015, and (3) J. Dai, Y Li, K. He, J. Sun, R-FCN: Object Detection via Region-based Fully Convolutional Networks. arXiv:1605.06409v2 [cs.CV], 2016.

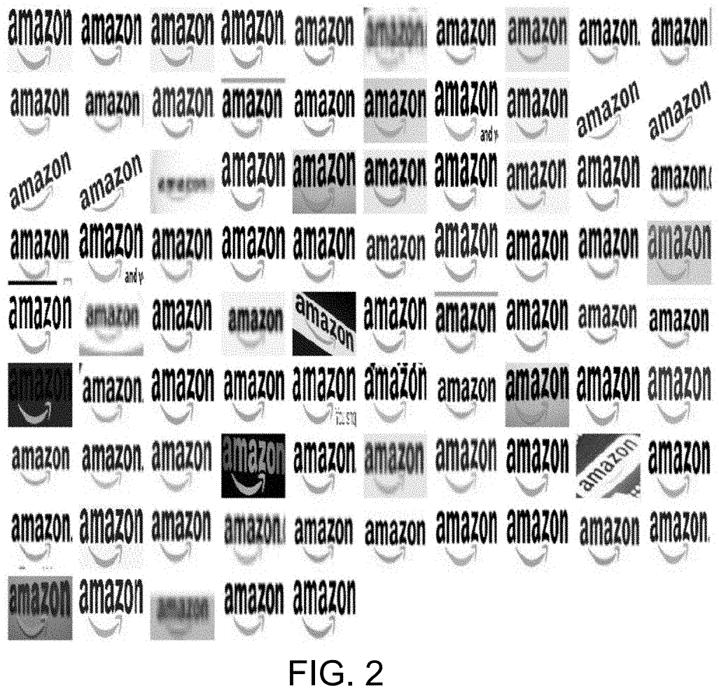

Compared to prior attempts that use classical computer vision approaches to detect logos on web pages, object detection convolutional networks have many advantages. They can support a very large number of object classes, which cause scaling issues for older techniques. Even for a specific logo, object detection convolutional networks can learn from many examples used by hackers or adversaries that may otherwise circumvent a technique that is based on a single or a small number of templates. FIG. 2 illustrates the quantity and diversity of naturally occurring web logos for even a specific example logo. Object detection convolutional networks can also learn features that classical detection techniques cannot, due to factors such as size and lack of detail, which are common in logos presented on UI displays.

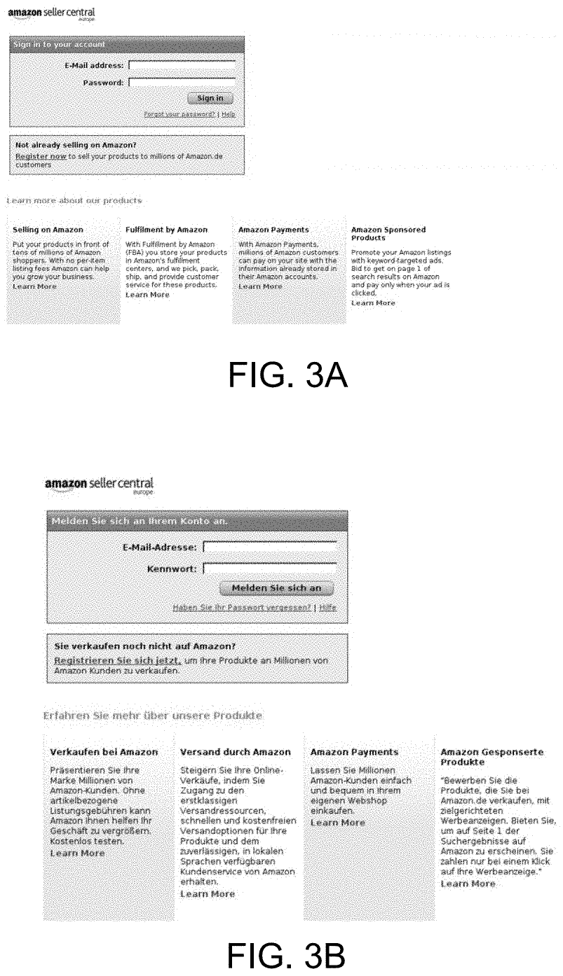

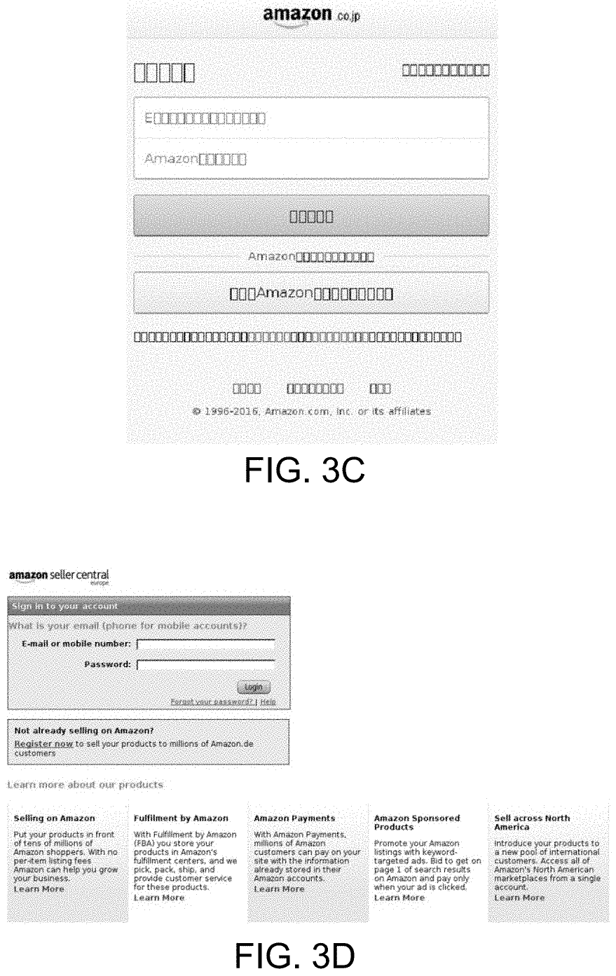

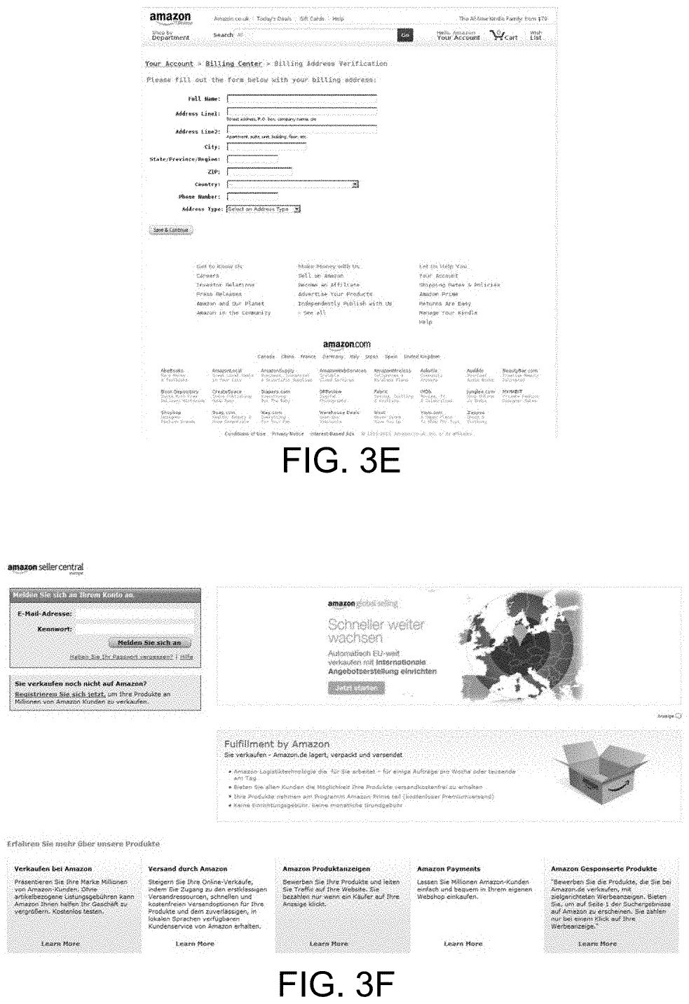

Other instances of convolutional network applications in phishing detection (see, e.g., https://github.com/duo-labs/phinn) apply image classification to the whole webpage screenshot, or repeatedly apply it to different quadrants of the page. Image classification with such an approach can only detect a phishing page if the whole screenshot is visually identical or similar to the legitimate version of the page. Such an approach therefore cannot detect the vast majority of phishing examples that are not overall visually similar to the legitimate page they are imitating. FIGS. 3A through 3F show the diversity of some example phishing pages that mimic a legitimate brand source. These examples illustrate that phishing pages may not, and often do not, present a display layout that is similar to the legitimate source's layout.

The object detection convolutional networks of the described embodiments detect the specific logos within each of the examples shown in FIGS. 3A through 3F, regardless of how the overall website is arranged, whereas an image classification convolutional network trained only on the legitimate login page for the brand will not detect any of the examples.

The example embodiment of the logEye procedure starts on a user device when a user opens on a web URL in a browser. The logEye procedure may be implemented by software or firmware executing on a processor, by a hardware-based state machine, or other techniques known in the art for implementing a process.

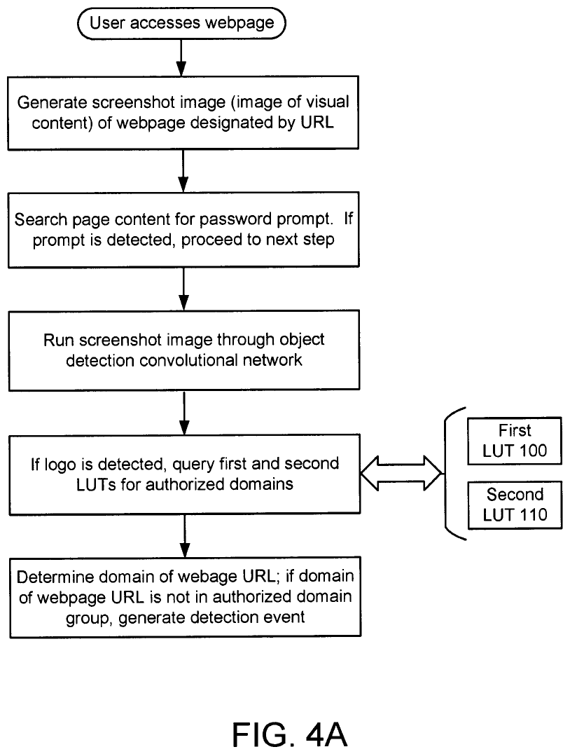

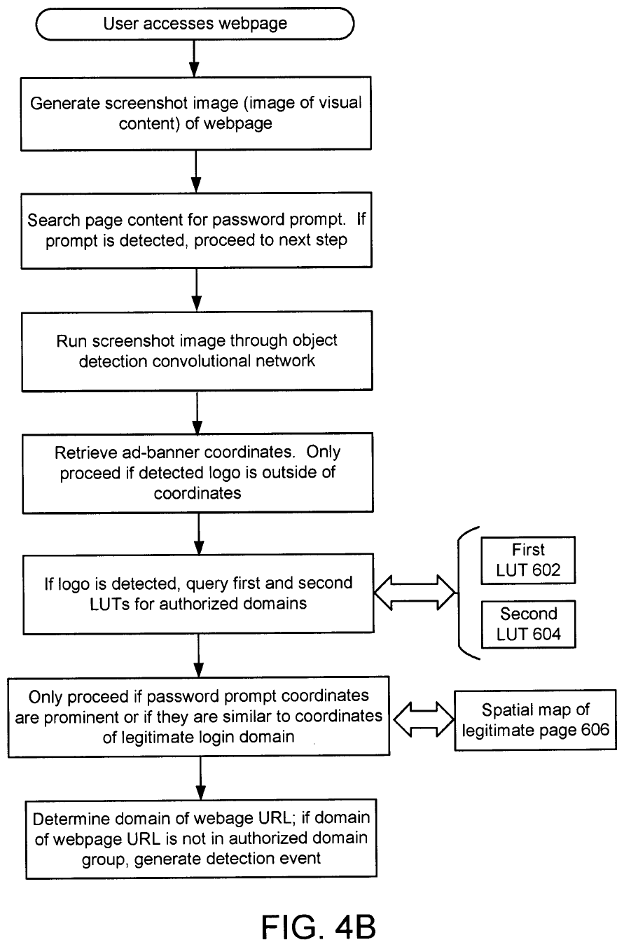

An agent (i.e., a sub-procedure of the overall logEye procedure), running locally on the device, may determine whether a loaded login web page contains a password prompt. If the agent detects a password prompt, the agent generates a web page screenshot (i.e., an image of the visual content of the web page) and inputs the screenshot into the object detection convolutional network. If the convolutional network detects any logo, the agent determines, using the first LUT 100 and the second LUT 110, the associated brand and the associated domain set for each detected logo. The agent further determines the URL domain of the login page. If the resolved URL domain of the login page is not in that associated set of the second LUT 110, then a detection event is generated. FIG. 4A summarizes the example logEye procedure described above. FIG. 4B shows an alternative logEye procedure, further comprising additional steps that facilitate ad-banner stripping and login spatial analysis

On a user device, the logEye procedure can run as a single agent, or it can be run as a pair of agents in which the object detection convolutional network is run in an agent that is separate from an agent doing the other steps. For example, a user PC device may have a single agent that runs as a browser extension that executes the whole logEye procedure. Alternatively, the same user PC may have separate agent that runs only the convolutional network, while all other steps are executed via an agent in a browser extension. As set forth elsewhere herein, the agent or agents of the described embodiments may be implemented by software or firmware executing on a processor, by a hardware-based state machine, or other techniques known in the art for implementing a process.

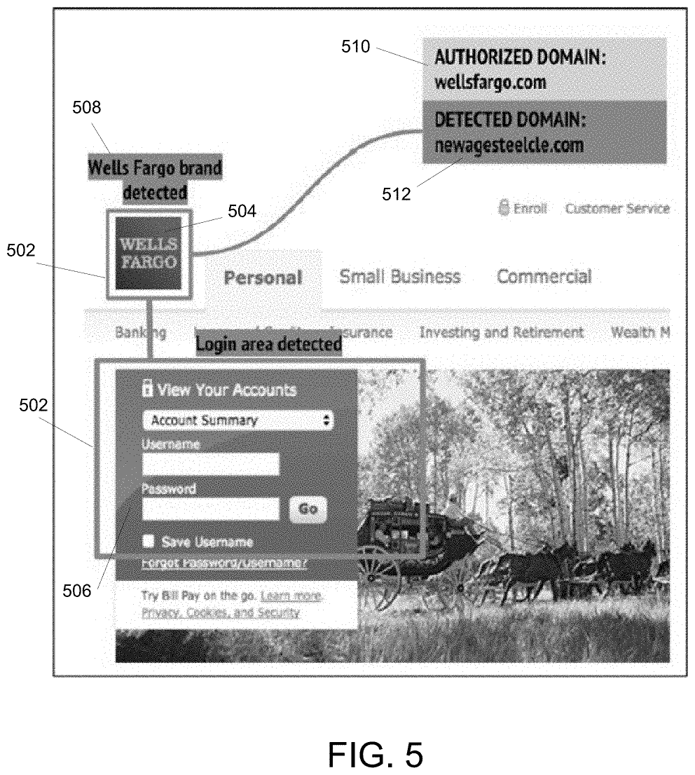

A detection event may comprise a user alert, which displays an image showing visually where on the webpage a logo was detected, and/or indicating that the user is not on an authorized login domain for that brand. FIG. 5 illustrates an example of such a user interface. In this example, a box overlay 502 is provided to show the relevant logo 504 and a user identification/password prompt 506, along with an indication of brand detection 508, authorized domain 510 associated with the detected brand, and the domain 512 detected as being associated with webpage URL. The authorized domain may be distinguished by the actual webpage URL domain using color (e.g., green or blue for authorized domain 510, and red or orange for actual domain 512). The user interface may further comprise deactivating buttons or other functionality on the webpage to prevent the user from entering credential information when a phishing detection event has occurred.

Embodiments of the logEye procedure may include determining the coordinates of advertisement banners on a web page, and when the object detection convolutional network detects a logo, the logEye procedure will only proceed to a potential detection event if the logo coordinates lie outside the coordinates of the advertisement banners. This ensures that the detected logo belongs to the visual content of the web page itself and not the visual content of an advertisement.

Embodiments of the logEye procedure may perform spatial analysis of the detected login prompt. The spatial analysis may determine whether the detected login prompt is positioned prominently on the web page or only peripherally positioned. For example, if the login prompt coordinates lie within the center region of the screenshot, then it may be considered prominent. The center region may be determined, for example, as a fraction of the overall web page dimensions, about the center point of the webpage. If the login prompt is not prominent, then the agent does not proceed to a detection event. This avoids occasional web pages that display incidental logos and contain a peripheral login prompt in the corner of the web page (e.g., a news or blog website).

The spatial analysis may further compare the coordinates of the detected login prompt to login prompt coordinates of a corresponding legitimate page. In this instance, an additional table on the device may store the login prompt coordinates of the legitimate login domains for each brand in the first table. After the previous spatial analysis step, if the logEye procedure determines that the login prompt is not prominent, but if the coordinates of the detected logo's legitimate domain are spatially similar to the coordinates of the login prompt detected by the agent, then the agent can proceed to a detection event. This handles cases where a detected logo's legitimate login page has an unusual login prompt location, such as the top right corner.

LogEye can additionally use visual fingerprinting to detect phishing URLs sharing identical image patterns with previously identified phishing URLs. Visual fingerprinting may use a visual hash function to map a screenshot image to a hexadecimal (or other basis) hash. Identical image inputs will hash to an identical hash output. If multiple phishing pages hosted across multiple URLs have an identical screenshot, then storing a visual hash of just one URL in a remote database makes detection on user devices simple. An agent running on a user device, with access to the database of visual hashes, can simply generate the visual hash of the screenshot of a URL and submit the hash as a query to the remote database. If the database returns a positive match, then the agent on the device can generate a detection event independent of other detection measures. Duplicate phishing screenshots are very common, particularly when hackers use open source phishing development kits. Compared to other signature based approaches for recording malicious URLs, visual hashes have the advantage of working independently of changes in the backend HTML, code if the visual appearance of a web page is identical.

Visual hash functions used for visual fingerprinting can include scale invariant hash functions. A scale invariant hash function will map two images appearing at different scales to the same hash. Scale invariant hashing is helpful when the same URL renders at different scales on different device hardware and operating systems.

Embodiments of the LogEye procedure may have its two-agent instance, as described herein, run across a pair of hardware platforms. The agent running the object detection convolutional network can run on a remote server, while the other agent, executing all other logEye steps, runs on the user device (e.g., PC, laptop, smart-phone etc.) in a browser extension. In this embodiment, the user device agent sends a screenshot image, after it is rendered, to the remote server, which in turns sends back detection data once the object detection convolutional network processes the image. The logEye hybrid architecture has the advantage of running the object detection convolutional network on optimized hardware (e.g., graphical processing units), which can process images considerably faster than the hardware available on a typical user device.

Embodiments of the LogEye procedure can also run either its single or double agent instance entirely on a remote server, instead of on a user device. In this embodiment, the logEye procedure is not triggered with a user opening a link in a browser on their device. Instead, the process starts with a client device submitting a URL or set of URLs to one or more agents running on the server. The server agent(s) then execute all logEye steps remotely from the client device. Once the last step completes, the server agent(s) return to the client a message containing either a detection event or a safe page notification.

### MailEye

Another embodiment of the invention may detect and address deceptive emails via an analogous process to logEye example embodiment described herein. An example embodiment, referred to herein as mailEye, uses an object detection convolutional network and lookup tables (LUTs) stored on a user device to alert users when logos appear in emails coming from unauthorized sender addresses. This protects users both from deceptive emails containing links to phishing pages and from deceptive emails containing malicious attachments and code files.

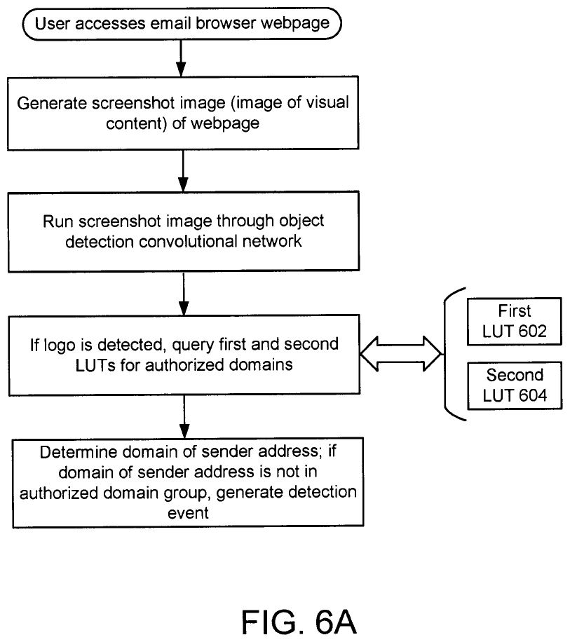

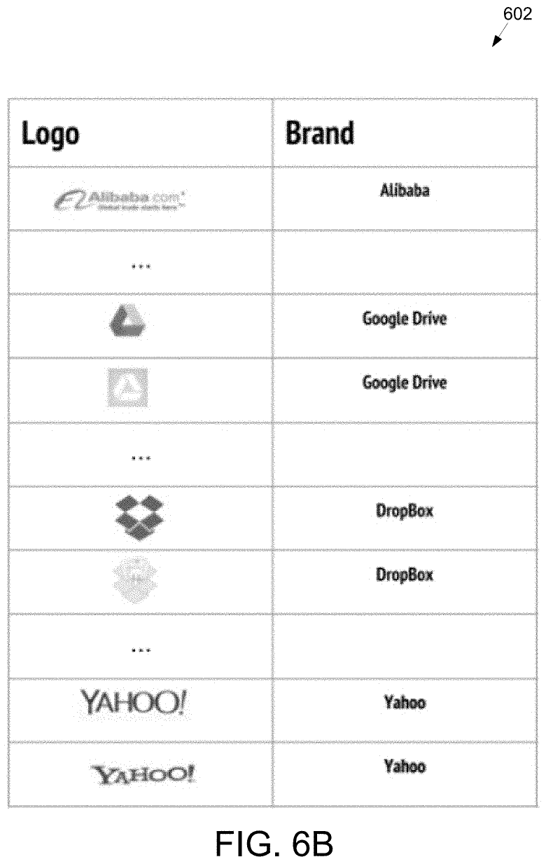

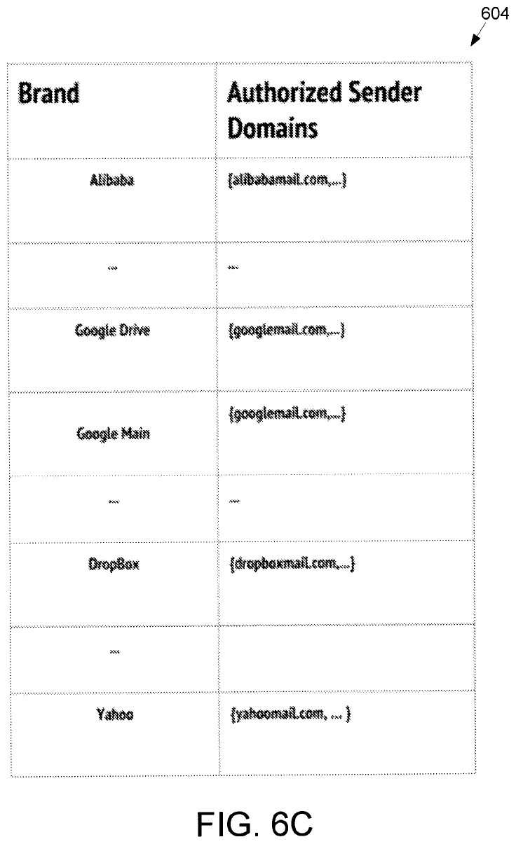

As described herein with respect to logEye, mailEye utilizes a pair of LUTs stored on a user device (e.g., PC, laptop, smart-phone). The first LUT associates one or more logo images or sets of logo images with a particular brand name or brand ID, similar to the corresponding table in logEye. The second LUT associates the brand in table one with a set of authorized email sender domains. FIG. 6A summarizes an example mailEye embodiment. FIG. 6B illustrates an example embodiment of the first LUT 602 shown in FIG. 6A, and FIG. 6C illustrates an example embodiment of the second LUT 604 shown in FIG. 6A.

MailEye may comprise an object detection convolutional neural network that is trained to detect the logos listed in the first LUT 602 on screenshots of email web pages. The development and deployment of the object detection convolutional network for mailEye follows a similar prescription to the one described herein with respect to the example logEye procedure.

Embodiments of the mailEye procedure starts when a user opens an email on their device in a web email client. An agent (i.e., a sub-process of the mailEye procedure), running locally on the device, may generate a web page screenshot of the email (i.e., an image of the visual content of the email) and input the screenshot into the object detection convolutional network. If the convolutional network detects any logo, the agent determines from the two tables the associated brands and the associated set of sender domains for that logo. If the sender address domain is not in the associated set of authorized sender domains, then a detection event is generated.

Similar to the example logEye procedure, the example mailEye procedure may run as a single agent on a user device, or it may run as a pair of agents in which the object detection convolutional network is run in an agent that is separate from an agent doing the other steps.

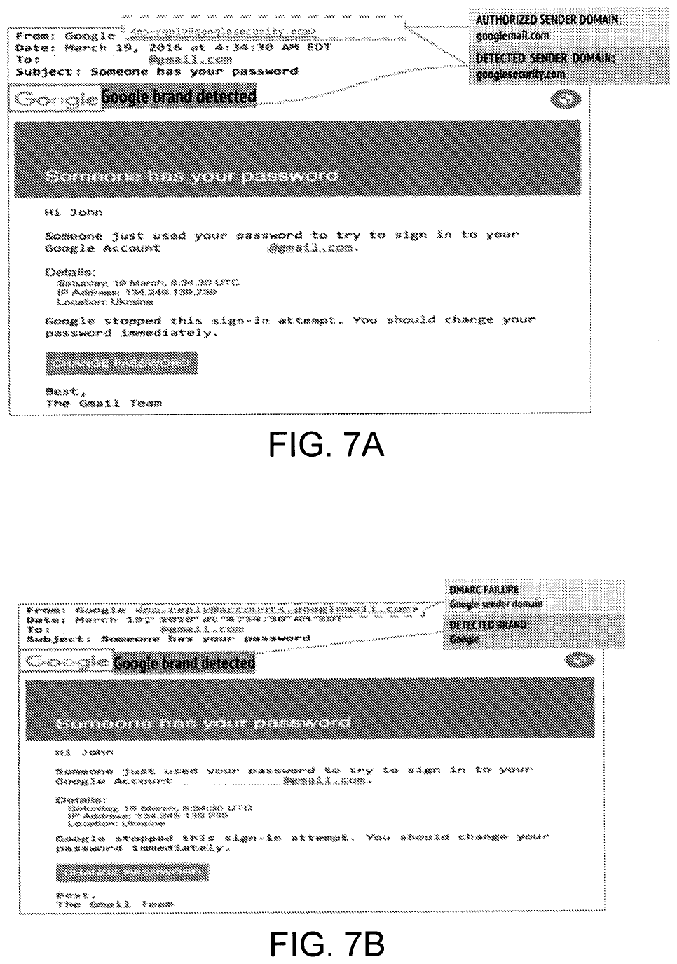

The detection event for mailEye may include a user alert that displays an image showing visually where on an email web page a logo was detected and indicating that the email sender address is not valid for the detected brand. FIGS. 7A and 7B illustrate an example of such a user alert. Furthermore, a detection event can include deactivating links and buttons on the email that may download or execute malicious code on the user device.

Similar to the example logEye procedure, the mailEye procedure may make use of visual fingerprinting to identify a malicious email based off a visual hash of the screenshot of the email.

Similar to the example logEye procedure, the mailEye procedure may have its two-agent configuration run across a pair of hardware platforms. The agent running the object detection convolutional network may run on a remote server while the other agent executing all other mailEye steps runs on the user device (e.g., PC, laptop, smart-phone etc.) in a browser extension.

The mailEye procedure may be integrated with an existing Domain-based Message Authentication, Reporting and Conformance (DMARC) policy on a user device. If an email message fails any associated DMARC policy (e.g., SPF, DKIM, etc.), then the mailEye procedure may generate a detection event after detecting a logo with the object detection convolutional network. This detection event can be generated independently of whether the sender domain matches the authorized set of domains. If an email sender address and logo detection are consistent according to the mailEye tables, but the sender address fails a DMARC policy check, then mailEye can enhance the user alert and indicate both a deceptive logo and deceptive sender address, as demonstrated in the example UI shown in FIG. 7B. In existing systems, DMARC policy failure by itself often does not prevent quarantined messages from being accessed.

### clickEye

Embodiments of the ClickEye procedure are analogous to the example logEye and mailEye embodiments described herein. However, instead of alerting users when logos appear on unauthorized login domains or on emails from unauthorized sender addresses, the ClickEye procedure alerts a user when they click on logos in their browser that result in unauthorized web destinations or downloads. the ClickEye procedure includes two sub-procedures that run on user devices (e.g., PC, laptop, smart-phone). Embedded Link Verification detects and warns the user if an embedded link they click goes to an unauthorized URL destination. Icon-Download Verification alerts and warns users if a click action would result in an unauthorized download.

The clickEye Embedded Link Verification procedure alerts an end user when the end user clicks on or otherwise selects an embedded link associated with a logo in their browser that would lead to an unauthorized web URL. Such deceptive embedded links are commonly used in fraudulent advertising banners or in deceptive logo click-icons (e.g., Red Cross, Google Docs, etc.) that lead to a phishing or malicious URL. The clickEye Embedded Link Verification procedure components are similar to those described herein with respect to the logEye and mailEye embodiment components.

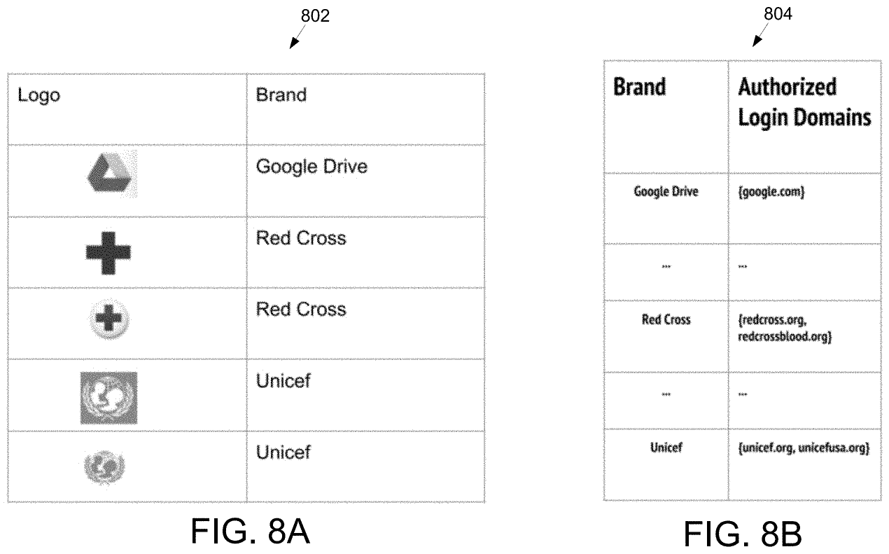

The clickEye embedded Link Verification procedure components consist of a pair of LUTs, a first LUT 802 that matches logos to brands, and a second LUT 804 that matches brands to a set of authorized domain destinations. FIGS. 8A and 8B illustrate an example embodiment of the first LUT 802 and the second LUT 804. Embedded Link Verification further includes an object detection convolutional network that is trained to detect the logos listed in the first table. The development and deployment of the object detection convolutional network for Embedded Link Verification follows a similar prescription to the one in logEye and mailEye. The Embedded Link Verification process can be run as a single or pair of agents running on the user device (e.g., laptop, PC, or smart-phone). Just like in the logEye and mailEye cases, in the case of the pair of agents, one agent runs only the object detection convolutional network, while all other steps are executed on the other agent.

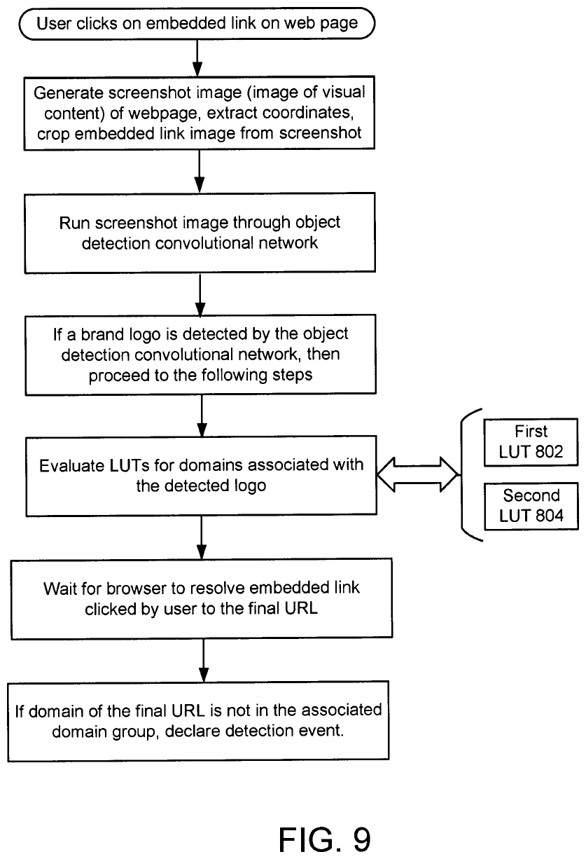

FIG. 9 illustrates an example embodiment of the clickEye Link Verification procedure. The example embodiment of the clickEye procedure starts when a user clicks on an embedded link in their browser. As used herein, the term “clicks” or “clicks on” refers to a user selecting a region or object on the web page, by clicking with a mouse device, tapping on a touch-sensitive screen, or other UI selection facilities known in the art. An agent on the device generates a screenshot image of the current web page and coordinates of the clicked embedded link are generated. Using the coordinates, the rectangle image of the clicked embedded link is cropped from the image screenshot of the whole web page. The embedded link image is then processed by the object detection convolutional network. If the object detection convolutional network detects a logo in the embedded link image, then a further verification procedure is triggered. The verification procedure first waits for the browser to resolve the clicked embedded link to its final URL. When the final URL has been resolved, the verification process queries the detected brand in second LUT 804 to determine the authorized domains. If the domain of the resolved URL is not in the authorized group from the second LUT 804, then a detection event is triggered. The detection event may alert the user about the malicious embedded link, deactivate links and actions on the web page after is loads, or communicate the malicious URL to a remote database.

An example embodiment of the ClickEye Icon Download Verification procedure follows an analogous process to the Embedded Link Verification procedure described herein. The ClickEye Icon Download Verification procedure alerts users if they click on an icon on a web page in their browser that results in an unauthorized download. Hackers commonly masquerade clickable buttons that trigger malicious downloads behind icons or action buttons that appear ordinary or benign to users. Examples include malicious email attachments disguised with an ‘Adobe’ or ‘Word’ icon, or a clickable malicious download disguised with the ‘exit/close’ icon of a pop up box.

The example embodiment of the clickEye Icon Download Verification procedure has a similar structure to the clickEye Embedded Link Verification procedure, but instead of containing authorized destination domains, its second LUT comprises authorized file formats. It consists of a table stored on the user device (e.g., PC, laptop, smart-phone) that associates icon images with a set of authorized formats. For certain non-download action icons (e.g., common web navigation buttons), there are no authorized file formats. These cases indicate no file whatsoever should be downloaded if such an icon is clicked. The example embodiment of the Icon Download Verification procedure further includes an object detection convolutional network that is trained to detect the logos listed in the first table. The development and deployment of the object detection convolutional network follows the same prescription as logEye, mailEye, and Embedded Link Verification. Similar to the logos in the logEye and mailEye tables, a particular logo in the Icon Download Verification table may appear near identical in legitimate instances, but in actual phishing examples it may appear visually diverse.

The example Icon Download Verification procedure can be run as a single or pair of agents running on the user device (e.g., laptop, PC, or smart-phone). Just like in the example embodiments of the logEye and mailEye procedures described herein, in the case of the pair of agents, one agent runs only the object detection convolutional network, while all other steps are executed on the other agent.

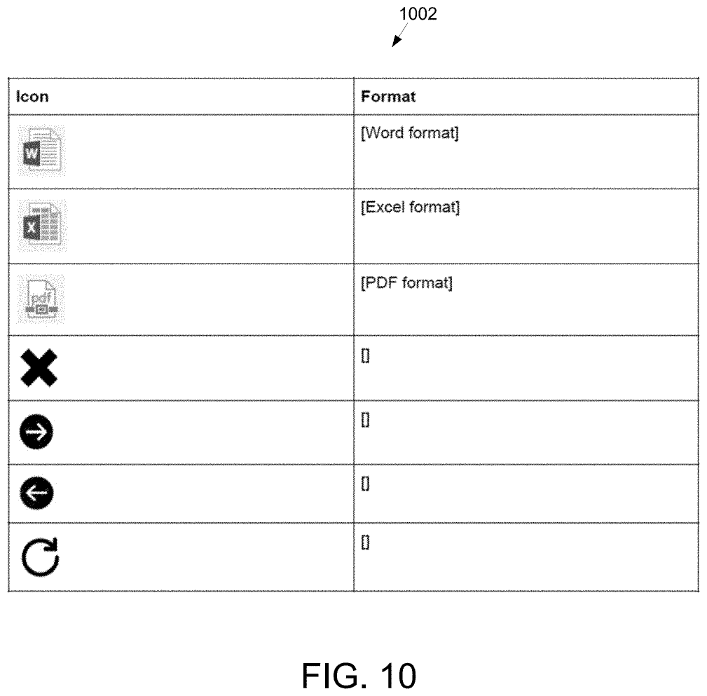

Icon Download Verification starts when a user clicks a button on a web page in their browser that triggers a download event. If a click triggers a download event, the agent generates a web page screenshot, extracts the coordinates of the image that was clicked, and crops a rectangle image from the whole screenshot. The cropped click image is then processed by the object detection convolutional network. If the object detection convolutional network detects a logo in a LUT 1002, it checks the authorized file formats associated with the detected logo in the LUT 1002. If there are no associated formats, then a detection event is generated. If there are authorized formats, then the agent checks that the filetype in the HTML header of the download button contains one of the authorized formats. If the filetype is not authorized, a detection event is generated. FIG. 10 illustrates an example embodiment of the LUT 1002.

A detection event may alert the user displaying visually where on the download button a deceptive icon is detected or quarantine the downloaded file.

Similar to the logEye and mailEye embodiments described herein, the clickEye procedures can have their two-agent configuration run across a pair of hardware platforms. The agent running the object detection convolutional network may run on a remote server while the other agent executing all other steps runs on the user device (e.g., PC, laptop, smart-phone etc.) in a browser extension.

### LockPass

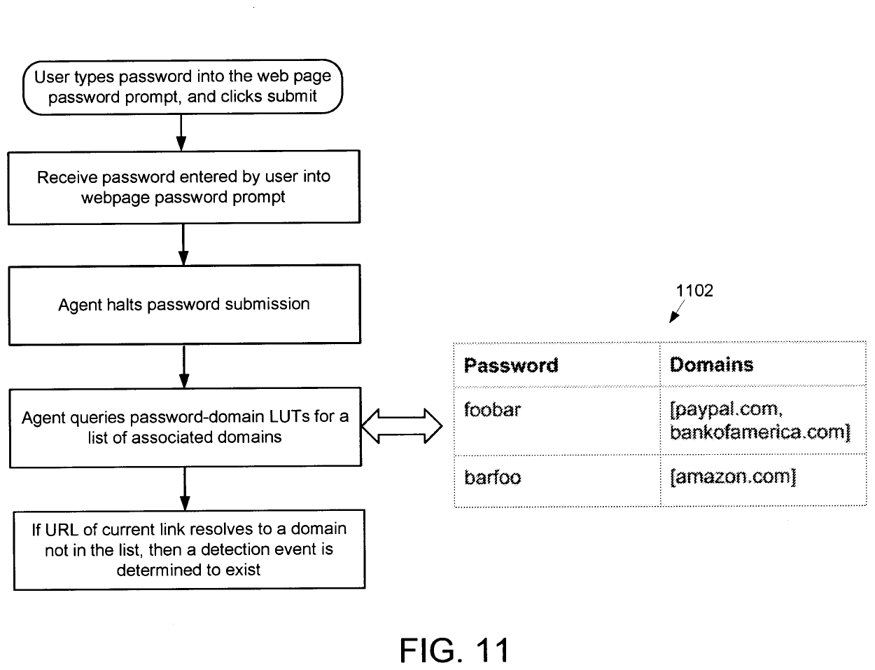

The purpose of the lockPass embodiment of the invention is to prevent passwords being stolen. lockPass protects user passwords via an association between user passwords and login domains. In its simplest instance, lockPass involves storing a list of passwords in a LUT 1102 on a user device (e.g., laptop, PC, smart-phone, etc.). Each password stored in the LUT 1102 has an associated set of domains on which the user in fact legitimately uses the associated password for login. When text is typed into a password prompt on a webpage by a user, a lockPass procedure is triggered that searches a password column of a first LUT 1102 for the typed text. If there is a password matching the text in the LUT 1102, then the process checks whether the domain of the webpage matches any of the associated domains in an “associated domain” column of the LUT 1102. If the domain of the webpage does not match any associated domains, then a user alert is triggered. FIG. 11 illustrates an example embodiment of the lockPass procedure.

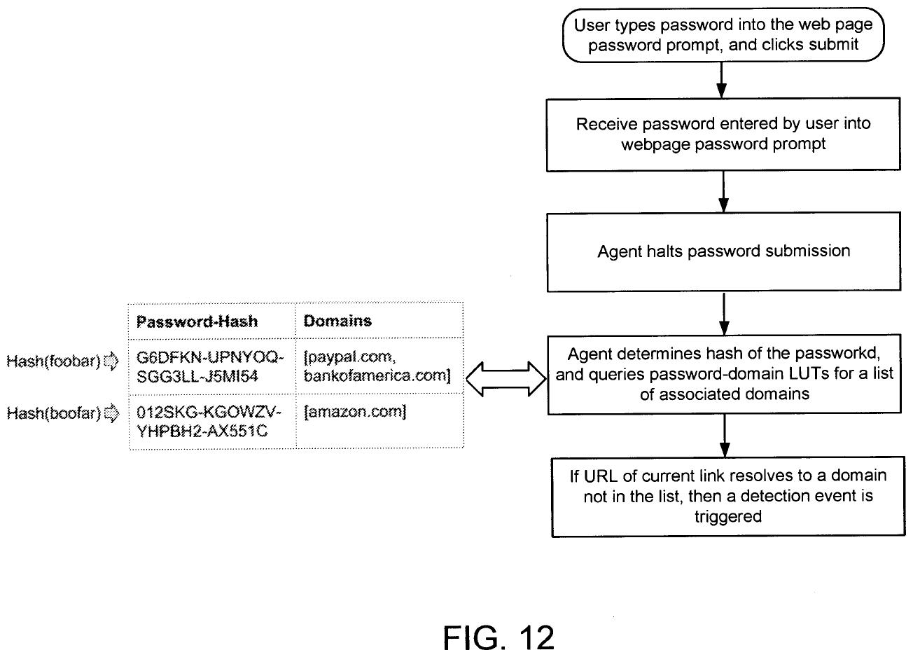

An alternative example embodiment of the LockPass procedure uses a cryptographic hash of the user's password instead of the plaintext. A hashed password consists of the hashed result of the plaintext original password text. The hashing itself can be accomplished by any standard hashing algorithm known in the art (e.g., SHA-1). Such a procedure maps a plaintext input, of arbitrary size, into a fixed output length. This provides identical functionality to the original lockPass procedure embodiment, while avoiding the vulnerability of storing plaintext passwords on a user device in case an adversary accesses the user's device. FIG. 12 illustrates an example embodiment of the lockPass procedure.

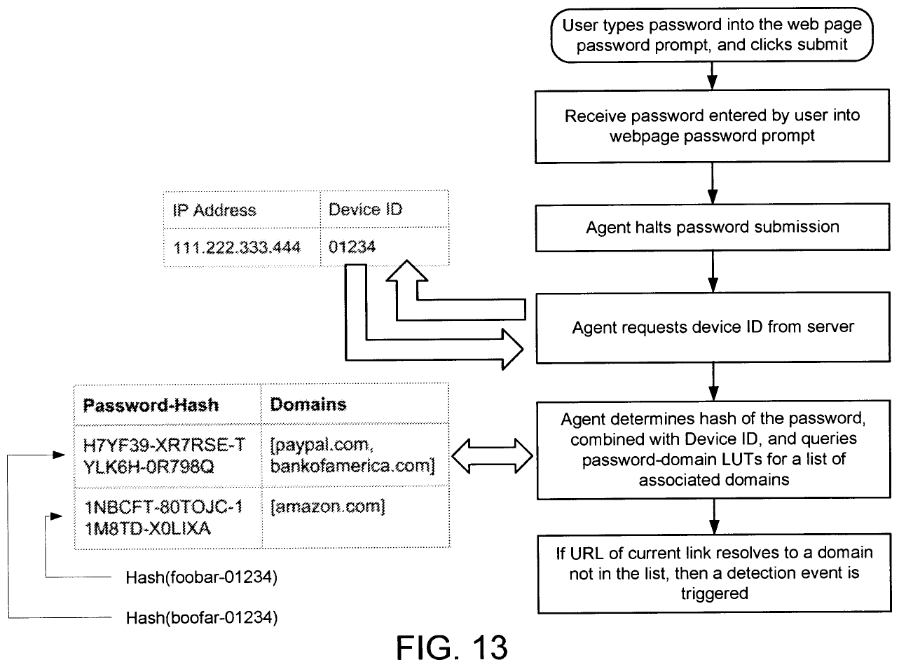

Yet another alternative example embodiment of the lockPass procedure incorporates the use of a cloud server that stores a unique device ID. In this instance, the user device stores hashes resulting from the combined input of both the plaintext passwords and the device ID. When a user types text into a password prompt on a webpage, the process first requests its device ID from a server. The alternative lockPass procedure then combines this device ID with the password plaintext to generate the hash. This alternative lockPass embodiment provides identical functionality as the previous lockPass embodiments, while avoiding the vulnerability of an adversary potentially guessing password hashes that use a known hash function (e.g., SHA-1). FIG. 13 summarizes this alternative lockPass embodiment.

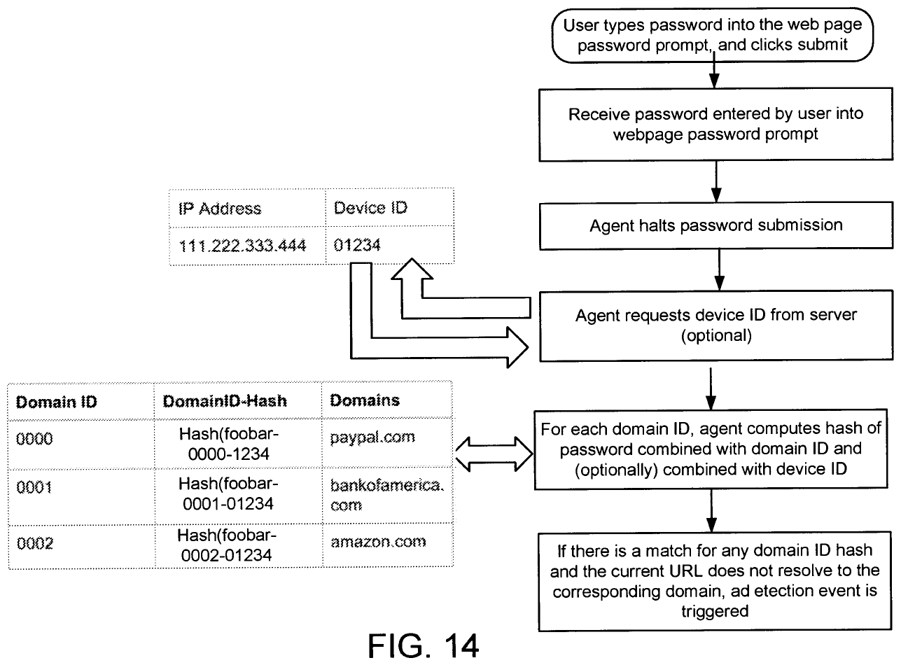

Another embodiment of the lockPass procedure may incorporate an additional domain ID into the stored hashes. Here, the user device stores hashes resulting from the combined input of the plaintext passwords and domain IDs in a LUT. The domain ID could be the plaintext of the domain itself or a unique ID code. The input to the hash could optionally also use the device ID described in the previous section. In this instance, once the user types their password, a separate hash is generated for each domain ID during the LUT lookup. For each hash that is generated with a domain ID, the hash is matched against the corresponding hash in the LUT. If there is a match and the current URL does not resolve to the corresponding domain, then a detection event is triggered. Note that, in this instance, each password-domain hash only has a single associated domain, even if a user uses the same password for multiple domains. This embodiment retains full LockPass functionality of all prior embodiments while avoiding the vulnerability of storing duplicate hashes that would indicate duplicate password use to an adversary. FIG. 14 illustrates this embodiment of the lockPass procedure, which includes the device ID option.

Unlike prior art password manager products, the lockPass procedure embodiments do not require a master password and do not interfere with the user's default password use and behavior. It simply protects passwords from being submitted into incorrect domains. In the last of the alternative embodiments, the lockPass procedure accomplishes this without storing password plaintext (via hash), with a concealed hash function (via device ID), and without duplicate hashes (via domain ID).

### keyMail

The KeyMail embodiment of the invention protects users in an organization from spear phishing emails. Spear phishing involves the sending of an email, apparently from a known or trusted sender (e.g., a known colleague). Rather than targeting user credentials or delivering an exploit onto a user device, spear phishing emails are often engineered to target and influence specific recipients to take a real-world action, such as wiring funds to an account number. Using a distributed agent running on user devices and a central database of email headers, embodiments of the keyMail procedure enables email recipients to verify that the email was sent from the specified sender.

For a given organization, keyMail may include a dedicated remote database, which stores a special hash for each email that was sent from and to an email address internally within the organization. It also includes a distributed agent running on all organization devices, each with access to the remote database.

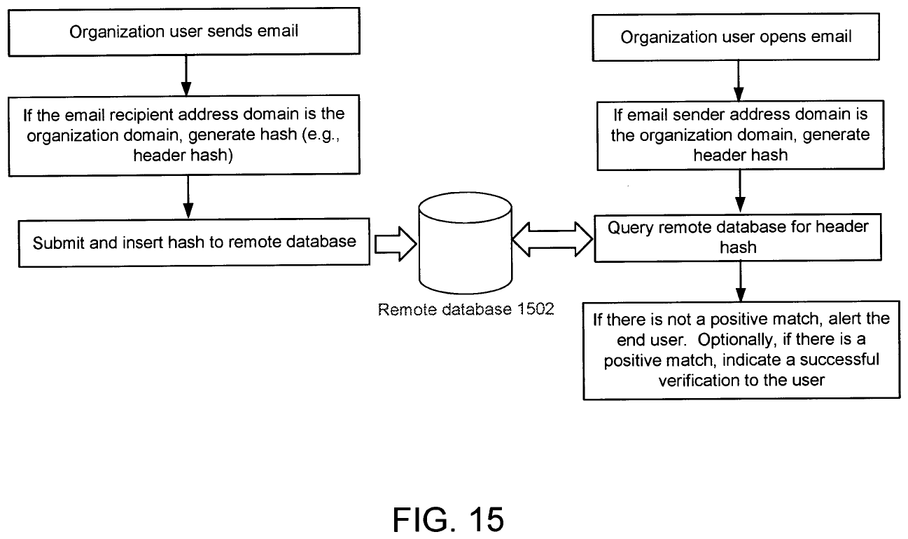

An “internal” embodiment of the keyMail procedure may run on each individual user device in an organization (i.e., internal to an organization). On a given device (e.g., laptop, PC, smart-phone) within an organization, an email send event to a recipient domain address with the organization domain triggers the agent to generate a hash resulting from the combined input of the email header elements. For example, the email header elements combined in the hash input may include the sender, recipient, date timestamp, and subject. Once the hash is generated, the agent submits the hash to the dedicated remote database server where it is inserted. Similarly, on a given device within an organization, an email open event with a sender domain address with the organization domain triggers the agent to determine the hash created from the same elements of the opened email. The determined hash is then submitted to the dedicated remote database server to query. If a comparison of the hashes results in a match, the agent is notified and the agent generates a successful verification display to the user on the device. Conversely, if there is no positive match at the remote database server, the agent generates an alert to the user on the device. FIG. 15 illustrates an example embodiment of the internal keyMail procedure.

A “global” embodiment of the keyMail procedure additionally verifies emails sent between users in separate organizations when both organizations have an embodiment of keyMail deployed. In this embodiment, in addition to a dedicated remote database for each organization's hashed headers, the global keyMail embodiment includes a remote record of organization domain names and their associated database ID's.

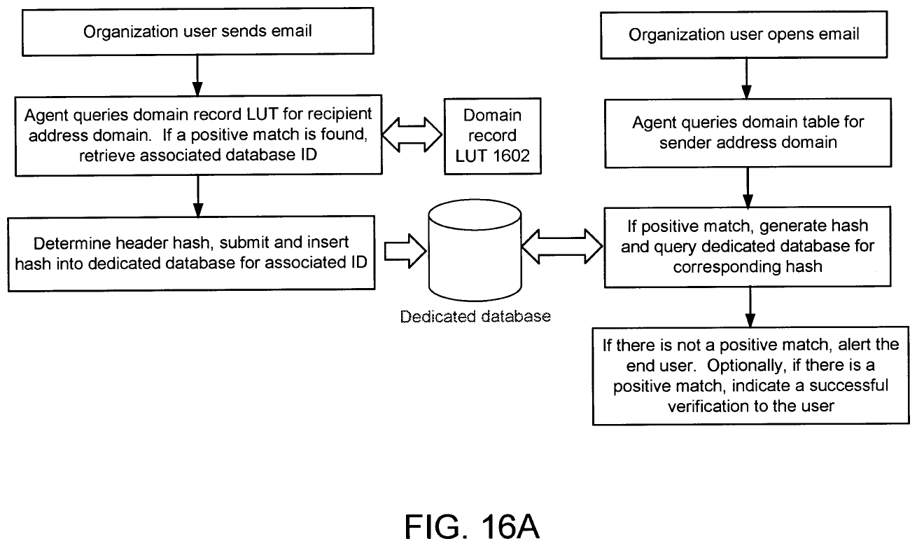

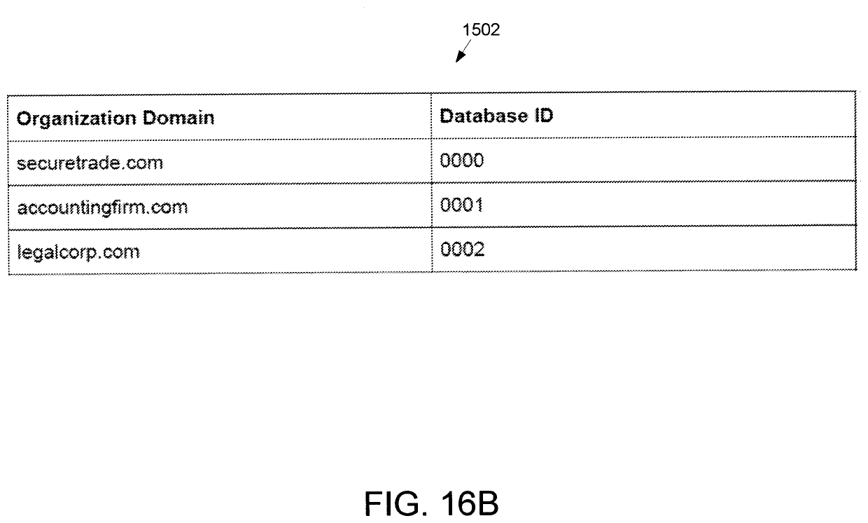

For the global keyMail embodiment, on a given device within an organization, an email send event triggers the agent to query the remote domain name record with the recipient address domain of the sent email. If there is a match for the domain of the recipient address, the agent retrieves the associated database ID of the recipient address domain, generates the header hash, and inserts the hash into the dedicated database for the recipient address domain. Similarly, on a given device within an organization, an email open event triggers the agent to query the remote domain name record with the sender address domain of the opened email. If the there is a match for the domain of the sender address, then the agent generates the header hash of the opened email and queries its organization's own dedicated database. If there is a domain match for the sender address, but there is no match for the header hash, then a user alert is generated. FIG. 16A illustrates an example embodiment of the global keyMail procedure. FIG. 16B illustrates an example domain record LUT 1602 shown in FIG. 16A.

### chainMail

ChainMail achieves the same sender-recipient verification as keyMail while mitigating the risk of a dedicated database being compromised by an adversary. ChainMail also provides additional protection to internal email records, ensuring they are not retroactively modified by users. For a given organization, chainMail creates a private peer to peer network of agent nodes that each stores an identical record of header hashes. Each header hash associated with an internal email is digitally signed by its sender with a unique private-public key pair. The header hash record is itself stored in a blockchain structure on each agent, ensuring immutability of verified email send events. The header hash blockchain is kept in sync across all agents via a private consensus protocol. Unlike public blockchain networks, the agents on a chainMail network are permissioned allowing for a fast consensus protocol. The header hash stored in the distributed blockchain is itself hashed content, so sender-recipient email privacy is preserved.

For a given organization, each chainMail user is assigned a public-private key pair associated with their organization email address. ChainMail runs a pair of local agents on each user device that is permissioned by an authority. One agent interfaces with the specific user email client and contains the user private-public key pair. The other agent serves as a node in the chainMail private peer to peer network. All node agents are identical. Each node agent includes an updated list of public keys for chainMail users in the organization and a record of internal email header hashes stored in the form of a linked hash list or blockchain.

When an email send event occurs on a device with a recipient address containing the organization domain, the email agent generates a header hash of the email, identical to the header hash described in keyMail. The header hash is then signed using the user private key and passed to the local node agent connected to the peer to peer network. The local node agent timestamps the signed header hash, randomly selects a peer node in the network to lead a private consensus, and sends the signed header hash to the leader node agent.

When the leader node receives the signed header hash, it broadcasts the signed header hash to its peers and waits to receive back a set number of verifications. An individual agent node verifies the header hash by validating the signature and ensuring the public key belongs to a user in the organization. The leader node only requires validation from a limited number of agent nodes, such as a fixed number or percentage of agent nodes connected to the network. Alternately, any number of well-known private consensus methods can be used (e.g., PBFT, Juno, Raft, et al.).

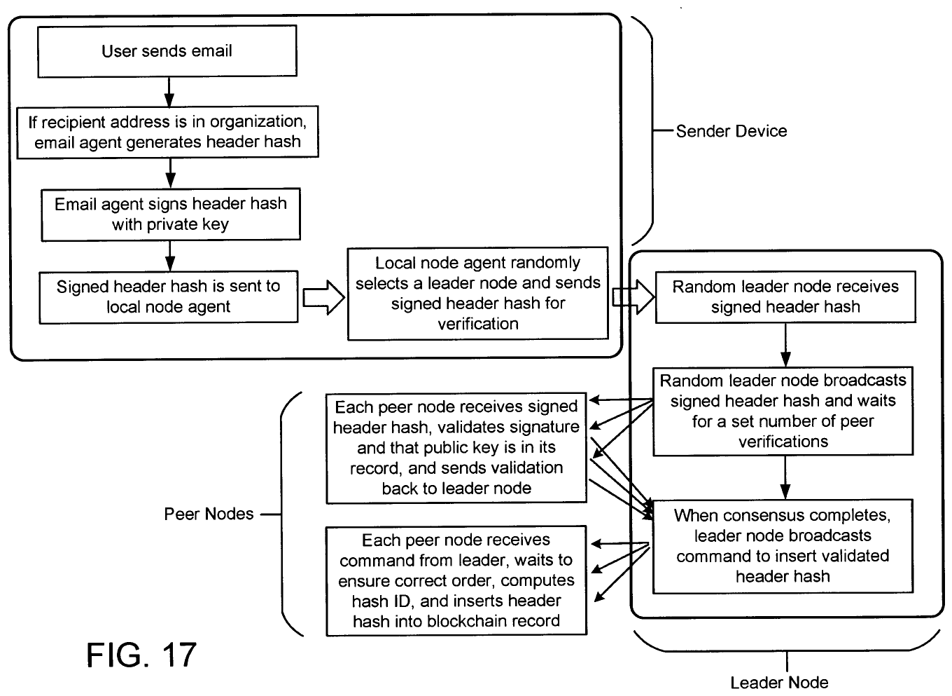

Once the leader node determines a consensus, it broadcasts a command to insert the validated header hash into the blockchain. Each node agent that receives the command waits a period to ensure another validated header hash does not arrive with an earlier timestamp. The node then converts the timestamp of the validated header hash to an integer ID. The agent node computes a hash ID from the combined input of the previous header hash ID and the content of the current header hash. This header hash is then added to its local blockchain record. FIG. 17 illustrates an example embodiment of the chainMail procedure.

Replacing the timestamp with an integer ID ensures no user can potentially infer the identity associated with a public key if some users have knowledge about specific times when other users send email.

When an internal email is opened with the sender address containing the organization domain, the email agent computes the header hash and queries the local node agent on its device for the header hash. If there is no match, then a user alert is generated by the email agent. This logic flow on the recipient device is identical to the corresponding logic in keyMail, only the queried database is a local blockchain record.

The chainMail private network can also include additional support agent nodes that run on external devices (e.g., servers) in addition to user devices. These external support node devices only run node agents and do not run email agents. These ensure that a fast private consensus can always be achieved, even when only a small number of user devices are online and communicating (e.g., during the night in a single time zone enterprise).

The distributed chainMail record enables organizations to confirm that email records have not been retroactively tampered with. At any time, email server records can have all internal email header hashes computed and compared with the blockchain record contained in any agent node. This achieves both enhanced database security against outsiders desiring to spoof internal communications, and increased protection against untrusted users desiring to modify email records.

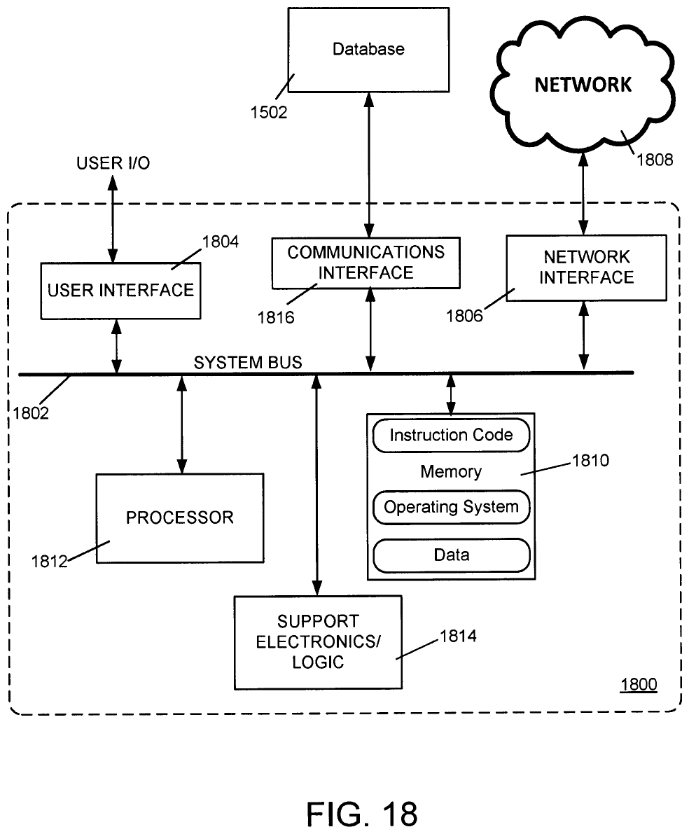

FIG. 18 is a diagram of an example internal structure of a processing system 1800 that may be used to implement one or more of the embodiments herein. Each processing system 1800 contains a system bus 1802, where a bus is a set of hardware lines used for data transfer among the components of a computer or processing system. The system bus 1802 is essentially a shared conduit that connects different components of a processing system (e.g., processor, disk storage, memory, input/output ports, network ports, etc.) that enables the transfer of information between the components.

Attached to the system bus 1802 is a user I/O device interface 1804 for connecting various input and output devices (e.g., keyboard, mouse, displays, printers, speakers, etc.) to the processing system 1800. A network interface 1806 allows the computer to connect to various other devices attached to a network 1808. Memory 1810 provides volatile and non-volatile storage for information such as computer software instructions used to implement one or more of the embodiments of the present invention described herein, for data generated internally and for data received from sources external to the processing system 1800.

A central processor unit 1812 is also attached to the system bus 1802 and provides for the execution of computer instructions stored in memory 1810. A graphical processing unit (not shown) may be included, in addition to or instead of the central processor unit. The system may also include support electronics/logic 1814, and a communications interface 1816 available to provide an interface to a specific hardware component, for example the remote database 1502 shown in FIG. 14.

In one embodiment, the information stored in memory 1810 may comprise a computer program product, such that the memory 1810 may comprise a non-transitory computer-readable medium (e.g., a removable storage medium such as one or more DVD-ROM's, CD-ROM's, diskettes, tapes, etc.) that provides at least a portion of the software instructions for the invention system. The computer program product can be installed by any suitable software installation procedure, as is well known in the art. In another embodiment, at least a portion of the software instructions may also be downloaded over a cable communication and/or wireless connection.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

While example embodiments have been particularly shown and described, it will be understood by those skilled in the art that various changes in form and details may be made therein without departing from the scope of the embodiments encompassed by the appended claims.

What is claimed is:

1. A method of detecting a phishing event, comprising:
by a processor and a memory with computer code instructions stored thereon, the memory operatively coupled to the processor such that, when executed by the processor, the computer code instructions cause the system to implement:
acquiring an image of visual content rendered in association with a source, and identifying a domain of the source;
performing an object detection operation, using an object detection convolutional neural network (CNN), on one or more brand logos located within the visual content, to detect an instantiation of one or more targeted brands;
determining, based on the object detection operation, that at least a portion of the visual content resembles content of a candidate brand;
comparing the domain of the source with one or more authorized domains of the candidate brand; and
declaring a phishing event when the comparing indicates that the domain of the source is not one of the authorized domains of the candidate brand.

2. The method of claim 1, wherein the source is a uniform resource locator (URL), and the visual content originates from an entity associated with the URL.

3. The method of claim 2, further comprising determining that the visual content includes personally identifiable information.

4. The method of claim 1, wherein the object detection is performed as a first agent, and the remaining steps are performed as a second agent.

5. The method of claim 4, wherein the first agent is configured to operate on a first hardware platform, and the second agent is configured to operate on a second hardware platform.

6. The method of claim 2, further comprising, upon declaring a phishing event, displaying an indication of one or more of (i) relevant logo, (ii) brand detection, (iii) authorized domain associated with the detected brand, (iv) domain detected as being associated with the detected brand, (v) domain detected as being associated with the URL, and (vi) notification as to a mismatch between the domain detected as being associated with the detected brand and the domain detected as being associated with the URL.

7. The method of claim 1, further comprising performing a visual fingerprinting of the image of visual content by generating a visual hash of the visual content and comparing the generated visual hash to one or more hashes of known phishing examples, and declaring a phishing event when the generated visual hash matches at least one of the hashes of known phishing examples.

8. The method of claim 1, wherein the source is an email agent configured to compile and communicate email content, and the visual content is at least a part of the email content.

9. The method of claim 8, further comprising, upon declaring a phishing event, displaying an indication of one or more of (i) a notification that an address of the email content does not match a sender domain and (ii) an indication of an identified target brand.

10. A method of detecting a phishing event, comprising:
by a processor and a memory with computer code instructions stored thereon, the memory operatively coupled to the processor such that, when executed by the processor, the computer code instructions cause the system to implement:
acquiring an image of rendered visual content;
generating image coordinates associated with an action triggered by a user click on the image, cropping a region of the image according to the coordinates to form a cropped region, and identifying a characteristic corresponding to a final terminus associated with the triggered action;
performing an object detection operation, using an object detection convolutional network (CNN), on the cropped region of the image to detect a brand logo located within the region;
determining, based on the object detection operation, that the detected brand logo resembles content of a candidate brand;
comparing the characteristic associated with the triggered action, with one or more authorized characteristics associated with the candidate brand; and
declaring a phishing event when the comparing indicates that the characteristic associated with the triggered action is not one of the authorized characteristics of the candidate brand.

11. The method of claim 10, wherein the triggered action is an activation of an embedded link, and the characteristics associated with the triggered action and the candidate brand are authorized domain destinations.

12. The method of claim 10, wherein the triggered action is an activation of a download event, and the characteristics associated with the triggered action and the candidate brand are authorized file formats

13. The method of claim 10, wherein the object detection is performed by a first agent, and the remaining steps are performed by a second agent.

14. The method of claim 13, wherein the first agent is configured to operate on a first hardware platform, and the second agent is configured to operate on a second hardware platform.

15. A method of detecting an unauthorized password event, comprising:
by a processor and a memory with computer code instructions stored thereon, the memory operatively coupled to the processor such that, when executed by the processor, the computer code instructions cause the system to implement:
receiving a password entered by a user into a webpage password prompt;
determining a domain associated with the webpage;
upon receiving the password, halting a submission of the password to a source of the webpage;
querying a password-domain record for a list of domains approved for the password;
comparing the domain associated with the webpage to the domains approved for the password; and
preventing the password from being sent to the webpage when the domain associated the webpage does not match one or more of the associated domains.

16. The method of claim 15, wherein the password-domain record comprises at least one of:
(i) a hash of the password associated with the approved domain; and
(ii) the hash of the password associated with the approved domain, and one or both of:
(a) a hash associated with the approved domain, the hash being a hash of the password and the device ID; and
(b) a hash associated with the approved domain, the hash being a hash of the password, the device ID, and a domain ID.

17. A method of detecting a phishing event, comprising:
by a processor and a memory with computer code instructions stored thereon, the memory operatively coupled to the processor such that, when executed by the processor, the computer code instructions cause the system to implement:
sending, by a first user, an email associated with a sender domain;
generating a sender hash based on one or more components of the email, and storing the sender hash in a data storage facility;
receiving, by a second user, the email;
determining that the sender domain is an accepted organization domain;
when the determining establishes that the sender domain is the accepted organization domain, generating a receiver hash based on the one or more components of the email;
retrieving the sender hash from the memory; and
declaring a phishing event when the sender hash does not match the receiver hash.

18. The method of claim 17, further comprising upon receiving the email, comparing the sender domain to a domain associated with the receiver, and skipping the steps that follow receiving the email when the sender domain is different from the receiver domain.

19. The method of claim 17, wherein the data storage facility is one of (i) a remote database memory and (ii) a distributed data storage ledger, the distributed data storage ledger consisting of a set of nodes that maintain independent records, each of which is validated according to a private consensus procedure.

20. The method of claim 19, wherein the data storage facility is a distributed data storage ledger, and further comprising:
digitally signing, by the first user based on a private key of a key pair, the hash header, timestamping the signed hash header, and conveying the signed and timestamped hash header to a leader node in a peer-to-peer network;
broadcasting, by the leader node, the signed and timestamped hash header to one or more peer nodes in the peer-to-peer network;
verifying, by the one or more peer nodes, the signed and timestamped hash header by validating the signature and determining that the associated public key belongs to a user in a corresponding organization, and returning a verification result to the leader node;
declaring a consensus, by the leader node, based on the received verification result, according to a private consensus procedure;
broadcasting, by the leader node, a command to insert the timestamped hash header into a storage ledger of each peer node.

21. A non-transitory computer-readable medium with computer code instruction stored thereon, the computer code instructions, when executed by a processor, cause an apparatus to:
acquire an image of visual content rendered in association with a source, and identifying a domain of the source;
perform an object detection operation, using an object detection convolutional network (CNN), on one or more brand logos located within the visual content, to detect an instantiation of one or more targeted brands;
perform a spatial analysis of the visual content to identify one or more solicitations of personally identifiable information (PII);
determine, based on the object detection operation and the spatial analysis, that at least a portion of the visual content resembles content of a candidate brand;
compare the domain of the source with one or more authorized domains of the candidate brand; and
declare a phishing event when the comparing indicates that the domain of the source is not one of the authorized domains of the candidate brand.

22. A non-transitory computer-readable medium with computer code instruction stored thereon, the computer code instructions, when executed by a processor, cause an apparatus to:
acquire an image of rendered visual content;
generate image coordinates associated with an action triggered by a user click on the image, cropping a region of the image according to the coordinates to form a cropped region, and identifying a domain corresponding to a final terminus associated with the triggered action;
perform an object detection operation, using an object detection convolutional network (CNN), on the cropped region of the image to detect a brand logo located within the region;
determine, based on the object detection operation, that the detected brand logo resembles content of a candidate brand;
compare a characteristic associated with the triggered action, with one or more authorized characteristics associated with the candidate brand; and
declare a phishing event when the comparing indicates that the domain of the embedded link is not one of the authorized domains of the candidate brand.
